(19) United States
(12) Patent Application Publication
(10) Pub. No.: US 2018/0349818 A1
(43) Pub. Date: Dec. 6, 2018

(54) Methods and Systems for Evaluating Performance of a Physical Space

(71) Applicant: Google LLC, Mountain View, CA (US)

(72) Inventors: Melissa Ann Chan, Mountain View, CA (US); Thor Lewis, Mountain View, CA (US)

(21) Appl. No.: 14/613,497

(22) Filed: Feb. 4, 2015

(51) Int. Cl. G06Q 10/06

(52) U.S. Cl. CPC G06Q 10/0639

(57) ABSTRACT

Example implementations may relate to evaluating performance of physical spaces. In particular, a computing system receives sensor data from sensors positioned in a physical space. Based on the sensor data, the system determines one or more physical characteristics of one or more actors located in the physical space, where each of the one or more physical characteristics is associated with (i) a time that the sensor data is received and (ii) a location within the physical space of at least one actor from the one or more actors. Next, the system receives input data including a request for a performance metric indicating performance of a selected region within the physical space over a particular time period. The system then determines the performance metric based on an aggregation of physical characteristics, from the one or more determined physical characteristics, that are associated with the particular time period and the selected region.

### BACKGROUND

Physical spaces may be used for retail, manufacturing, assembly, distribution, and office spaces, among others. Over time, the manner in which these physical spaces are designed and operated is becoming more intelligent, more efficient, and more intuitive. As technology becomes increasingly prevalent in numerous aspects of modern life, the use of technology to enhance these physical spaces becomes apparent. Therefore, a demand for such systems has helped open up a field of innovation in sensing techniques, data processing, as well as software and user interface design.

### SUMMARY

Example implementations may relate to a computing system that receives sensor data from sensors positioned in a physical space. Using the sensor data, the computing system determines physical characteristics of actors located in the physical space. The actors may be people, objects, and/or machines, among others. Moreover, the computing system associates these physical characteristics with a time and/or a region within the physical space.

Given this arrangement, the computing system can receive input data, such as from a separate computing device, corresponding to a request for a performance metric that represents performance related to the physical space. Additionally, the request may correspond to performance over a particular time period and in a selected region within the physical space. After receiving the input data, the computing system can determine the requested performance metric by aggregating physical characteristics that are associated with the selected region and the particular time period.

In one aspect, a computing system is provided. The computing system includes one or more processors. The computing system also includes a non-transitory computer readable medium. The computing system further includes program instructions stored on the non-transitory computer readable medium and executable by the one or more processors to receive sensor data from one or more sensors positioned in a physical space. The program instructions are also executable to determine, based on the sensor data, one or more physical characteristics of one or more actors located in the physical space, where each of the one or more physical characteristics is associated with (i) a time that the sensor data is received and (ii) a location within the physical space of at least one actor from the one or more actors. The program instructions are additionally executable to receive input data including a request for a performance metric indicating performance of a selected region within the physical space over a particular time period. The program instructions are further executable to determine the performance metric based on an aggregation of physical characteristics, from the one or more determined physical characteristics, that are associated with the particular time period and the selected region.

In another aspect, a method is provided. The method involves receiving, by a computing system, sensor data from one or more sensors positioned in a physical space. The method also involves determining, based on the sensor data, one or more physical characteristics of one or more actors located in the physical space, where each of the one or more physical characteristics is associated with (i) a time that the sensor data is received and (ii) a location within the physical space of at least one actor from the one or more actors. The method additionally involves receiving input data including a request for a performance metric indicating performance of a selected region within the physical space over a particular time period. The method further involves determining the performance metric based on an aggregation of physical characteristics, from the one or more determined physical characteristics, that are associated with the particular time period and the selected region.

In yet another aspect, a non-transitory computer readable medium is provided. The non-transitory computer readable medium has stored therein instructions executable by one or more processors to cause a computing system to perform functions. The functions include receiving sensor data from one or more sensors positioned in a plurality of physical spaces. The functions also include determining, based on the sensor data, one or more physical characteristics of one or more actors located in the plurality of physical spaces, where each of the one or more physical characteristics is associated with (i) a time that the sensor data is received and (ii) a location within the plurality of physical spaces of at least one actor from the one or more actors. The functions additionally include receiving input data including a request for a performance metric indicating performance of one or more selection region within the plurality of physical spaces over a particular time period. The functions further include determining, for each of the one or more selection regions, the performance metric based on an aggregation of physical characteristics, from the one or more determined physical characteristics, that are associated with the particular time period and a given region from one or more selection region.

In yet another aspect, a system is provided. The system may include means for receiving sensor data from one or more sensors positioned in a plurality of physical spaces. The system may also include means for determining, based on the sensor data, one or more physical characteristics of one or more actors located in the plurality of physical spaces, where each of the one or more physical characteristics is associated with (i) a time that the sensor data is received and (ii) a location within the plurality of physical spaces of at least one actor from the one or more actors. The system may additionally include means for receiving input data including a request for a performance metric indicating performance of one or more selection region within the plurality of physical spaces over a particular time period. The system may further include means for determining, for each of the one or more selection regions, the performance metric based on an aggregation of physical characteristics, from the one or more determined physical characteristics, that are associated with the particular time period and a given region from one or more selection region.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 illustrates an example configuration of system for evaluating performance of physical spaces, according to an example implementation.

FIG. 2 is an example flowchart for determining a performance metric, according to an example implementation.

FIGS. 3A-3E illustrate an example graphical user interface (GUI), according to an example implementation.

FIG. 4 illustrates another example physical space, according to an example implementation.

### DETAILED DESCRIPTION

Example methods and systems are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

According to various implementations, described herein are methods and systems for evaluating performance of physical spaces such as retail spaces, for example. In particular, various sensors may be located within physical spaces and may provide data about physical entities in the physical space as well as data about events taking place within the physical space, among other types of data. A computing system may receive such data and may process the data to determine various physical characteristics related to people or objects in the physical space. Moreover, the computing system may associate these characteristics with a time and/or a region within the physical space.

Collection of data and subsequent processing of this data to determine the various characteristics may take place around the clock, thereby amounting to an extensive amount of easily accessible information about a physical space. Accessibility to this information may take place via an operator-geared or a consumer-geared graphical user interface (GUI). In particular, a device in communication with the computing system can display this GUI and allow a user to set search parameters. These search parameters can then be used as criteria for aggregation of this information such as for the purpose of evaluating performance of the physical space. For instance, a user may select search parameters such as a requested performance metric, a selected region within the physical space, and/or a time period, among others.

After selecting the search parameters, the computing system may receive these parameters and may subsequently determine the requested performance metric using the stored information that is related to the various physical characteristics. In this manner, operators of a physical space can determine performance of the space at any time and at any location within the space, thereby allowing the operators to determine ways to organize and optimize the physical space for the purpose of enhancing quality of service, sales metrics, and/or customer experience, among others. Similarly, other individuals, such as consumers, can use this system to determine areas of interest within the physical space and/or to optimize movement around the physical space, among other positive outcomes.

### II. Illustrative Systems

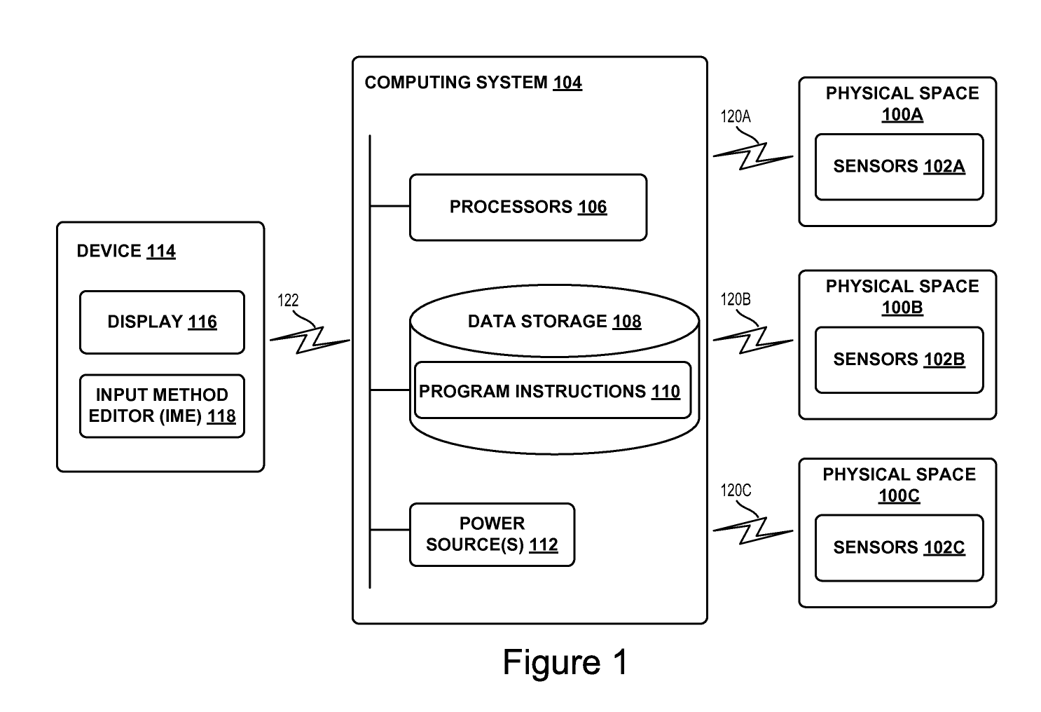

Referring now to the figures, FIG. 1 shows an example arrangement including one or more physical spaces 100A-100C each having one or more sensors 102A-102C, respectively. A physical space may define a portion of an environment in which people, objects, and/or machines may be located. The physical space may take on a two-dimensional or a three-dimensional form and may be used for various purposes. For instance, the physical space may be used as a retail space where the sale of goods and/or services is carried out between individuals (or businesses) and consumers. While various aspects of the disclosure are discussed below in the context of a retail space, example implementations are not limited to retail spaces and may extend to a variety of other physical spaces such as manufacturing facilities, distribution facilities, office spaces, shopping centers, festival grounds, and/or airports, among other examples. Additionally, while three physical spaces 100A-100C are shown in FIG. 1, example implementations may be carried out in the context of a single physical space or a plurality of physical spaces.

Example sensors in a physical space (e.g., sensors 102A-102C) may include but are not limited to: force sensors, proximity sensors, motion sensors (e.g., an inertial measurement units (IMU), gyroscopes, and/or accelerometers), load sensors, position sensors, thermal imaging sensors, facial recognition sensors, depth sensors (e.g., RGB-D, laser, structured-light, and/or a time-of-flight camera), point cloud sensors, ultrasonic range sensors, infrared sensors, Global Positioning System (GPS) receivers, sonar, optical sensors, biosensors, Radio Frequency identification (RFID) systems, Near Field Communication (NFC) chip, wireless sensors, compasses, smoke sensors, light sensors, radio sensors, microphones, speakers, radars, touch sensors (e.g., capacitive sensors), cameras (e.g., color cameras, grayscale cameras, and/or infrared cameras), and/or range sensors (e.g., ultrasonic and/or infrared), among others.

Additionally, the sensors may be positioned within or in the vicinity of the physical space, among other possible locations. Further, an example implementation may also use sensors incorporated within existing devices such as mobile phones, laptops, and/or tablets. These devices may be in possession of people located in the physical space such as consumers and/or employees within a retail space. Additionally or alternatively, these devices may be items on display such as in a retail space used for sale of consumer electronics, for example. Yet further, each of physical spaces 100A-100C may include the same combination of sensors or may each include different combinations of sensors.

FIG. 1 also depicts a computing system 104 that may receive data from the sensors 102A-102C positioned in the physical spaces 100A-100C. In particular, the sensors 102A-102C may provide sensor data to computing system via communication links 120A-120C, respectively. Communication links 120A-120C may include wired links and/or wireless links (e.g., using various wireless transmitters and receivers). A wired link may include, for example, a parallel bus or a serial bus such as a Universal Serial Bus (USB). A wireless link may include, for example, Bluetooth, IEEE 802.11(IEEE 802.11 may refer to IEEE 802.11-2007, IEEE 802.11n-2009, or any other IEEE 802.11 revision), Cellular (such as GSM, GPRS, CDMA, UMTS, EV-DO, WiMAX, HSPDA, or LTE), or Zigbee, among other possibilities. Furthermore, multiple wired and/or wireless protocols may be used, such as “3G” or “4G” data connectivity using a cellular communication protocol (e.g., CDMA, GSM, or WiMAX, as well as for “WiFi” connectivity using 802.11).

In other examples, the arrangement may include access points through which the sensors 102A-102C and/or computing system 104 may communicate with a cloud server. Access points may take various forms such as the form of a wireless access point (WAP) or wireless router. Further, if a connection is made using a cellular air-interface protocol, such as a CDMA or GSM protocol, an access point may be a base station in a cellular network that provides Internet connectivity via the cellular network. Other examples are also possible.

Computing system 104 is shown to include one or more processors 106, data storage 108, program instructions 110, and power source(s) 112. Note that the computing system 104 is shown for illustration purposes only as computing system 104 may include additional components and/or have one or more components removed without departing from the scope of the disclosure. Further, note that the various components of computing system 104 may be arranged and connected in any manner.

Each processor, from the one or more processors 106, may be a general-purpose processor or a special purpose processor (e.g., digital signal processors, application specific integrated circuits, etc.). The processors 106 can be configured to execute computer-readable program instructions 110 that are stored in the data storage 108 and are executable to provide the functionality of the computing system 104 described herein. For instance, the program instructions 110 may be executable to provide for processing of sensor data received from sensors 102A-102C.

The data storage 108 may include or take the form of one or more computer-readable storage media that can be read or accessed by the one or more processors 106. The one or more computer-readable storage media can include volatile and/or non-volatile storage components, such as optical, magnetic, organic or other memory or disc storage, which can be integrated in whole or in part with the one or more processors 106. In some embodiments, the data storage 108 can be implemented using a single physical device (e.g., one optical, magnetic, organic or other memory or disc storage unit), while in other embodiments, the data storage 108 can be implemented using two or more physical devices. Further, in addition to the computer-readable program instructions 110, the data storage 108 may include additional data such as diagnostic data, among other possibilities. Further, the computing system 104 may also include one or more power source(s) 112 configured to supply power to various components of the computing system 104. Any type of power source may be used such as, for example, a battery.

FIG. 1 further depicts a device 114 that is shown to include a display 116 and an Input Method Editor (IME) 118. The device 114 may take the form of a desktop computer, a laptop, a tablet, a wearable computing device, and/or a mobile phone, among other possibilities.

Note that the device 114 is shown for illustration purposes only as device 114 may include additional components and/or have one or more components removed without departing from the scope of the disclosure. Additional components may include processors, data storage, program instructions, and/or power sources, among others (e.g., all (or some) of which may take the same or similar form to components of computing system 104). Further, note that the various components of device 114 may be arranged and connected in any manner.

In some cases, an example arrangement may not include a separate device 114. That is, various features/components of device 114 and various features/components of computing system 104 can be incorporated within a single system. However, in the arrangement shown in FIG. 1, device 114 may receive data from and/or transmit data to computing system 104 via communication link 122. Communication link 122 may take on the same or a similar form to communication links 120A-120C as described above.

Display 116 may take on any form and may be arranged to project images and/or graphics to a user of device 114. In an example arrangement, a projector within device 114 may be configured to project various projections of images and/or graphics onto a surface of a display 116. The display 116 may include: an opaque or a transparent (or semi-transparent) matrix display, such as an electroluminescent display or a liquid crystal display, one or more waveguides for delivering an image to the user's eyes, or other optical elements capable of delivering an image to the user. A corresponding display driver may be disposed within the device 114 for driving such a matrix display. Other arrangements may also be possible for display 116. As such, display 116 may show a graphical user interface (GUI) that may provide an application through which the user may interact with the systems disclosed herein.

Additionally, the device 114 may receive user-input (e.g., from the user of the device 114) via IME 118. In particular, the IME 118 may allow for interaction with the GUI such as for scrolling, providing text, and/or selecting various features of the application, among other possible interactions. The IME 118 may take on various forms. In one example, the IME 118 may be a pointing device such as a computing mouse used for control of the GUI. However, if display 116 is a touch screen display, touch-input can be received (e.g., such as using a finger or a stylus) that allows for control of the GUI. In another example, IME 118 may be a text IME such as a keyboard that provides for selection of numbers, characters and/or symbols to be displayed via the GUI. For instance, in the arrangement where display 116 is a touch screen display, portions the display 116 may show the IME 118. Thus, touch-input on the portion of the display 116 including the IME 118 may result in user-input such as selection of specific numbers, characters, and/or symbols to be shown on the GUI via display 116. In yet another example, the IME 118 may be a voice IME that receives audio input, such as from a user via a microphone of the device 114, that is then interpretable using one of various speech recognition techniques into one or more characters than may be shown via display 116. Other examples may also be possible.

### III. Illustrative Methods

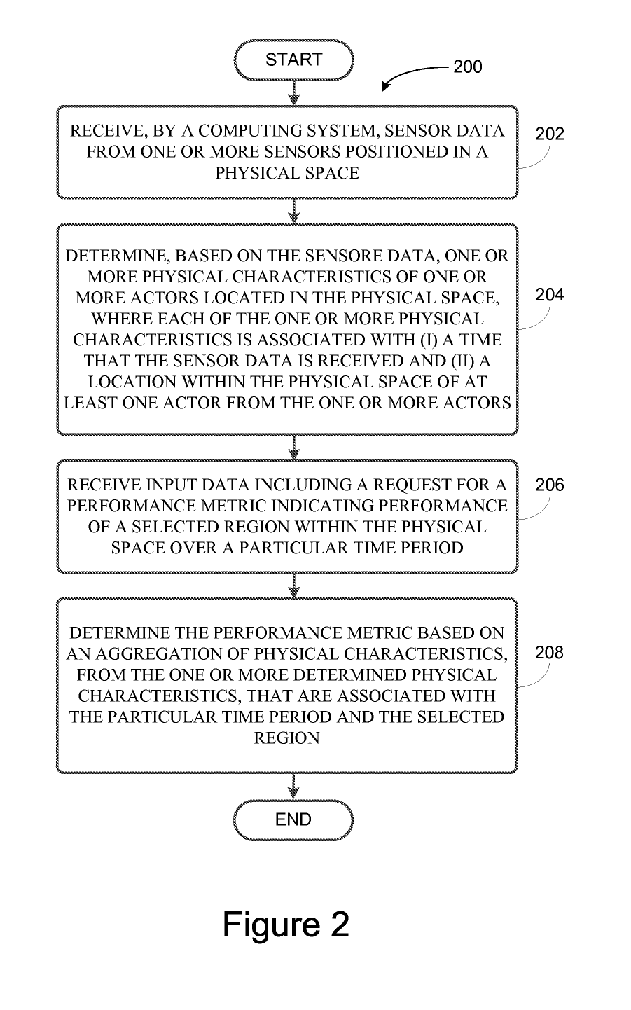

FIG. 2 is a flowchart illustrating a method 200, according to an example implementation. In particular, method 200 may be implemented to determine performance metrics that represent performance of a physical space.

Method 200 shown in FIG. 2 (and other processes and methods disclosed herein) presents a method that can be implemented within an arrangement involving, for example, the physical spaces 100A-100C, the computing system 104, and/or the device 114 described above in association with FIG. 1 (or more particularly by one or more components or subsystems thereof, such as by a processor and a non-transitory computer-readable medium having instructions that are executable to cause the device to perform functions described herein). Additionally or alternatively, method 200 may be implemented within any other arrangements and systems.

Method 200 and other processes and methods disclosed herein may include one or more operations, functions, or actions as illustrated by one or more of blocks 202-208. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the method 200 and other processes and methods disclosed herein, the flowchart shows functionality and operation of one possible implementation of present implementations. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the method 200 and other processes and methods disclosed herein, each block in FIG. 2 may represent circuitry that is wired to perform the specific logical functions in the process.

At block 202, method 200 involves receiving, by a computing system (e.g., computing system 104), sensor data from one or more sensors (e.g., sensors 102A) positioned in a physical space (e.g., physical space 100A).

In an example implementation, the computing system may receive the sensor data in the form of computer-readable data packets, among other possible forms. Additionally, the computing system may receive data from each sensor separately or may receive data from two or more sensor concurrently (e.g., such as within the same data packet). Further, the sensor data may be received continuously (e.g., in real-time) or may be received from time-to-time (e.g., periodically). Yet further, the sensor data may be received in the form of anonymized data streams. That is, sensor data representing information related to people located within the physical space may represent people as discrete entities. In this manner, the sensor data does not provide any information related to an individual identity of a person, thereby maintaining privacy of the individual.

Once the sensor data is received, some or all of the sensor data may be stored in data storage 108 and/or processed (e.g., using processors 106) to provide the functionality further discussed below. Additionally, the computing system may store a time related to the received sensor data. For instance, the computing system may use various time stamping techniques to establish a time that the sensor data is obtained by the sensors, a time that the sensor data (e.g., a data packet) is sent to the computing system, and/or a time that sensor data (e.g., a data packet) is received by the computing system, among others. This time may include a date, a day of the week, and/or a time of the day, among other possibilities.

Further, the computing system may additionally or alternatively store a location related to the sensor data. For instance, the computing system may encode location information onto the received data packets (e.g., receiving sensor identification information and determining a corresponding stored location of the identified sensor). Alternatively, the received data packets may already have the location information encoded thereon. In either case, the location information may be in the form of coordinates within the physical space, an address, and/or a list of characters representing a name (e.g., a name of a department within a retail space), among other possibilities.

Moreover, this location information may represent the location within a physical space of a particular sensor (or a set of sensors). However, in some cases, the received sensor data may provide information related to a location within the physical space that is not necessarily the same as the location of the sensor obtaining this sensor data. Thus, the location information may additionally or alternatively represent the location within the physical space that the received sensor data is associated with. As an example, the sensor data may include image data received from a camera located within the physical space. In this example, the location information may include the location of the camera within the physical space and/or may include a location associated with the image data provided by the camera. Other examples may also be possible.

At block 204, method 200 involves determining, based on the sensor data, one or more physical characteristics of one or more actors located in the physical space, where each of the one or more physical characteristics is associated with (i) a time that the sensor data is received and (ii) a location within the physical space of at least one actor from the one or more actors.

In some cases, the sensor data may relate to actors located within the physical space. In particular, the actors may define one of various physical entities located within the physical space (or within a plurality of physical spaces). For instance, actors may include people, animals, machines, robotic systems, and/or objects, among other possibilities. As such, the computing system may determine physical characteristics of one or more actors upon receiving sensor data.

Within examples, physical characteristics are features of a physical entity that measureable based on data received from one or more sensors. Specific examples of physical characteristics may include but are not limited to: body language (e.g., using depth sensors), facial expression (e.g., using facial detection sensors), face temperature (e.g., using thermal imaging sensors), body temperature, speed of movement, direction of movement, orientation in space, sex, age, language spoken, gaze direction, heart rate, height, weight, shape, and/or color, among other possibilities.

In an example implementation, the computing system may determine a value defining a physical characteristic. In one case, values representing the sensor data may be the same as a value defining the physical characteristic. For instance, sensor data representing face temperature may include a numerical value of the temperature data (e.g., 37° C.). In this instance, the value defining the physical characteristics may also be the numerical value of the temperature data. As such, the computing system may store (e.g., in data storage) the value defining the physical characteristics that is determined based on the sensor data.

In another case, values representing the sensor data may not necessarily be representative of a physical characteristics that the system is arranged to determine. In this case, the system may determine the value defining the physical characteristic based on, for example, determining a correlation between values found in obtained sensor data and values defining a physical characteristic (e.g., using a calculation or by reference to a table of values stored in data storage). For instance, sensor data representing facial expression may include a set of data points defining various facial features. While the computing system may store this set of data points, the system may additionally or alternatively determine a value representing a particular facial expression. In this instance, the computing system may determine that the set of data points corresponds to a smile, for example. The computing system may then store the value representing the particular facial expression. This value may be in the form of a number (e.g., smile=5; frown=1 etc.) or may be in the forms of a sequence of characters (e.g., “SMILE”), among other possibilities.

Further, the computing system may also associate a determined physical characteristic with time and/or location and may store the time and/or location information associated with the value defining the physical characteristics. In particular, the computing system may determine a time associated with a determined physical characteristic (e.g., a time of a smile). The system can make this determination using time related to the specific sensor data that is used for determination of the value defining the physical characteristic. For instance, if a data packet is time stamped with a time of 10 PM, then a physical characteristic that is determined using sensor data in this data packet may also have an associated time of 10 PM.

Additionally or alternatively, the computing system may determine a location within the physical space of at least one actor. This location may correspond to a location of the actor while obtaining sensor data that is then used for determination of a value defining a physical characteristic, thereby associating this value with the location. The system can determine location using location information related to the specific sensor data used for determination of the physical characteristic at issue. For instance, if a data packet has corresponding location of “shoe department” (e.g., within a retail space), then a physical characteristic (e.g., of a particular actor) that is determined using sensor data in this data packet may also have an associated location information of “shoe department”.

In a further aspect, the computing system may determine a confidence level in association with obtained sensor data and/or in association with a determined physical characteristic. For instance, confidence values might be based on the specific sensor obtaining the sensor data. As an example, different sensor models may result in different qualities of sensor data. In this example, the computing system may have stored thereon confidence values for different sensor models and may thus assign a confidence value to received sensor data based on the specific sensor (or set of sensors) obtaining this received sensor data. As such, sensor data obtained from a low quality sensor may be assigned a lower confidence value relative to sensor data obtained from a higher quality sensor.

In this manner, the computing system may also assign confidence values to physical characteristics that are determined based on the received sensor data. These confidence values may then be used to determine which physical characteristics should be used to determine the performance metrics further discussed below. For example, the computing system may only use values (i.e., defining physical characteristics) having associated confidence values that exceed a threshold confidence value. Other examples may also be possible.

At block 206, method 200 involves receiving input data comprising a request for a performance metric indicating performance of a selected region within the physical space over a particular time period.

In an example implementation, the computing system may receive the request from a device such as from device 114. In particular, device 114 may show a GUI on display 116 that allows for selection of search parameters. More specifically, this selection may take place by receiving user-input via IME 118 (e.g., selection using a pointing device or selection using touch on a touch screen display etc.). Selection of the search parameters may be in the form of: selecting a parameter from a drop-down menu, selecting a parameter by selection of a file, selecting a parameter by selection of an image, and/or selecting a parameter by entering text, among other possibilities.

In one example, a search parameter may involve a request for a particular performance metric (or multiple performance metrics). A performance metric defines a measure of performance/achievement of the physical space and is used to assess criteria such as: safety, time, cost, resources, scope, quality, and/or actions, among others. Note that specific examples of performance metrics are provided below in association with discussion of block 208 of method 200.

In one case, the performance metric may be an individual performance metric corresponding a single physical characteristic. For instance, the request for a particular performance metric may be a request for face temperature. As such, this particular performance metric may be the physical characteristic of face temperature. In another case, the particular performance metric may correspond to aggregation of several physical characteristics as further discussed below. For instance, the request for a particular performance metric may be a request for a level of happiness or a level of engagement. In this instance, a request for a level of happiness may require further computation using determined physical characteristics as further discussed below.

In yet another case, the particular performance metric may be customizable. That is, the GUI may provide for an option to create customized computations (e.g., formulas) for determining customizable performance metrics. In particular, the device 114 may receive selection of specific variables to be used for these customized computations. For instance, such variables may be selected in a pointing device gesture of “drag and drop” in which the user selects a virtual object (e.g., representing a variable) by “grabbing” the object and “dragging” the object to a different location within the GUI (e.g., a customization field).

More specifically, these variables may be specific physical characteristics (and/or existing performance metrics) to be used for determination of a customized performance metric. As an example, device 114 may receive user-input involving a formula for determining a level of interest (e.g., I) based on values defining a physical characteristic of gaze direction (e.g., G) and based on values defining a physical characteristic of heart rate (e.g., H). An example of such a formula may be: I=5*G+3*H. Alternatively, rather than having a user develop formulas, the computing system may have predefined formulas that are selected (and subsequently used for computation) based on the specific set of physical characteristics selected to be used for determining a customizable performance metric. Other examples may also be possible.

In another example, the GUI may also allow for selection of one or more regions within a physical space, within a plurality of physical spaces, and/or within a geographical area encompassing one or more physical spaces, among others. In the case of selecting one or more regions within a plurality of physical spaces, all the selected regions may be within the same physical space (from the plurality of physical space) or different selected regions may be within different physical spaces. Moreover, the GUI may also allow for selection of a particular physical space from the plurality of physical spaces. For instance, if the plurality of physical spaces is a chain of retail stores, then the GUI may allow for selection of one or more retail stores from the chain of retail stores.

Further, selection of a region may involve selection of a geographical region encompassing one or more physical spaces, such as selection of a continent, country, state, and/or city, among other possibilities. Additionally or alternatively, selection of a region may involve selection of a region within a physical space such as a retail store. In such cases, the selected region may be, for example, a department within a store or an aisle within a store, among other possibilities.

Various implementations may be possible for selection of the particular region. In an example implementation, the GUI may provide for selection of a region within a visual representation of the physical space (or of a geographical area). In one case, the GUI may show a (two-dimensional (2D) or three-dimensional (3D)) map of a physical space. In another case, the GUI may show a video feed of a physical location. In yet another case, the GUI may show an image of a physical space. In yet another case, the GUI may show a layout of a physical space, such as a layout extrapolated from a video feed or an image of the physical space. Other cases are also possible.

Within such an implementation, user-input may be received corresponding to selection of a predefined region shown in the visual representation (e.g., a city within a map of a geographical area). However, implementations are not limited to predefined regions as the GUI may also allow a user to define one or more regions for selection. For instance, the GUI may show a visual representation of a physical space and subsequent user-input may be received defining a custom region within the visual representation of physical space. Defining the custom region may involve selection of a 2D or 3D shape (e.g., square or cube etc.) followed by user-input gestures to determine the position of the shape within the visual representation as well as size of the shape and orientation of the shape, thereby defining the selected region using the shape. These user-input gestures may involve using a pointing device (or using touch on a touch screen display) at a desired position on the map. Alternatively, rather than selecting a shape, user-input may involve a drawing of a custom shape (e.g., an enclosed area or volume) on the map to define the selected region. In either arrangement, the resulting selected region may be a 2D section of the physical space or may be a 3D section of the physical space.

In yet another example, the GUI may allow for selection of a particular time period. Selection of a particular time period may involve: selection of a date range, selection of an hour range, selection of a date, selection of an hour, selection of a current time, selection one or more specific times, selection of one or more time ranges, selection of one or more days of the week, selection of one or more months, and/or selection of one or more years, among other possibilities.

Selection of such search parameters may allow the computing system to determine a performance metric defining performance of a selected region over a particular time period. As a specific example, the computing system may determine a level of engagement at an electronics department of a retail store during the month of April. In another specific example, the computing system may determine average face temperature, between noon and 3 PM each day, of both an electronics department of a retail store and a gaming department of the same retail store. Many other specific examples may also be possible.

While several example search parameters have been discussed, other search parameters may also be possible without departing from the scope of the disclosure. Moreover, the computing system may proceed to determine the performance metric, as further discussed below, after selection of the search parameters such as upon receiving user-input indicating that the system should proceed. For example, such user-input may correspond to a press of a button labeled: “calculate”, “analyze”, “complete”, or “continue”, among others. Other examples may also be possible.

At block 208, method 200 involves determining the performance metric based on an aggregation of physical characteristics, from the one or more determined physical characteristics, that are associated with the particular time period and the selected region.

Specific examples of performance metrics may include performance metrics that correspond to one or more of the following: a level of happiness, a level of engagement, face temperature, a number of smiles, and/or duration of stay, among others. Additionally, the performance metric may correspond to sales metrics such as a conversion rate. In particular, the conversion rate may define a rate of performance of a particular action. For instance, the action may be buying a product on display at a store or not buying the product on display at the store. As such, a conversion rate can represent a rate at which one or more items are purchased by one or more people in the physical space.

Moreover, the performance metric may correspond to a conversion rate relative to other performance metrics. As an example, the performance metric may indicate the rate at which an item is purchased when a region has a specific level of happiness. As another example, the performance metric may indicate the rate at which an item is purchased when a region has a specific average face temperature. In this manner, the performance metrics may allow for evaluation of performance of a physical space for the purposes of optimizing the physical space, product testing, and/or for driving business decisions, among other outcomes.

As noted above, determining the performance metric is based on an aggregation of physical characteristics that are associated with the particular time period and the selected region. Upon selection of the search parameters, the computing system may refer to the database to obtain information regarding previously determined values defining physical characteristics that satisfy the criteria defined by the selected search parameters. This information may reflect values defining physical characteristics of one or more actors that were located in the selected region at some point in time within the particular selected time period, where the particular obtained values define specific physical characteristics that are used for determining the requested performance metric.

For instance, the computing system may determine values defining physical characteristics that are associated with the selected region and/or the particular time period. The computing system may then determine the physical characteristics used for determination of the requested performance metric and may then select, from among the values defining physical characteristics that are associated with the selected region and/or the particular time period, the values defining physical characteristics used for determination of the requested performance metric. Alternatively, the computing system may first determine values defining physical characteristics used for determination of the requested performance metric and then determine, from among the values defining physical characteristics used for determination of the requested performance metric, the values defining physical characteristics that are associated with the selected region and/or the particular time period. Other sequences may also be possible. In any case, however, the computing system may proceed to determine the performance metric after obtaining the appropriate values to be used based on the search criteria.

In an example implementation, determining the performance metric may involve determining a weighted average of values defining the physical characteristics that are associated with the particular selected time period and the selected region. For example, a level of happiness (e.g., H) may be determined based on an aggregation of physical characteristics such as facial expression and body language (e.g., posture). Each facial expression may have a corresponding value (e.g., smile=10 and frown=1). Also, each posture may have a corresponding value (e.g., upright=10 and bent over=1). In this example, average facial expression, in the selected region over the particular time period, may correspond to a variable of X while average body language, in the selected region over the particular time period, may correspond to a variable of Y. Moreover, each such variable may be assigned a relative weight that may signify the importance of the variable relative to other variables. For instance, average facial expression may be assigned a weight of 3 while average body language may be assigned a weight of 2. Given this example, a resulting formula for determining a level of happiness based on a weighted average of the values may be: H=(3*X+2*Y)/(3+2).

In other implementations, determining the performance factors may involve other predetermined or customized computations (e.g., unrelated to determining a weighted average) that use values defining physical characteristics that are associated with the particular selected time period and the selected region. For example, a level of engagement (may also be referred to as “dwell time”) may be determined based on a single of physical characteristics such as gaze direction. In this example, a specific value for level of engagement may be assigned based on an average duration of time that one or more people, in the selected region over the particular time period, gaze in a direction of interest within the physical space. For instance, if the one or more people gaze in the direction of a specific product on display for an average of 5 seconds, a level of engagement may be assigned a value of 1. Whereas, if one or more people gaze in the direction of a specific product on display for an average of 5 minutes, a level of engagement may be assigned a value of 9. Other examples and implementations may also be possible.

In a further aspect, the computing system can also determine the performance metric for each of several selection regions in the event that several such regions are selected. Additionally, the computing system can also determine the performance metric for a particular physical space in the event that such a particular physical space is selected. Further, in the event that a 3D section of the physical space is selected, the computing system can also determine the performance metric based on an aggregation of physical characteristics that are associated with the 3D section of the physical space. Other aspects may also be possible.

Upon determining the performance metric, the computing system may send information, related to the determined performance metric, to the device (e.g., device 114) which requested the performance metric at issue. In some cases, the computing system may also send this information to other devices and/or may store this information in the database or at another location such as a cloud-based server, for example. After receiving this information, the device 114 may be arranged to portray this received information to the user of the device 114, such as via the GUI for example.

### IV. Example Graphical User Interface (GUI)

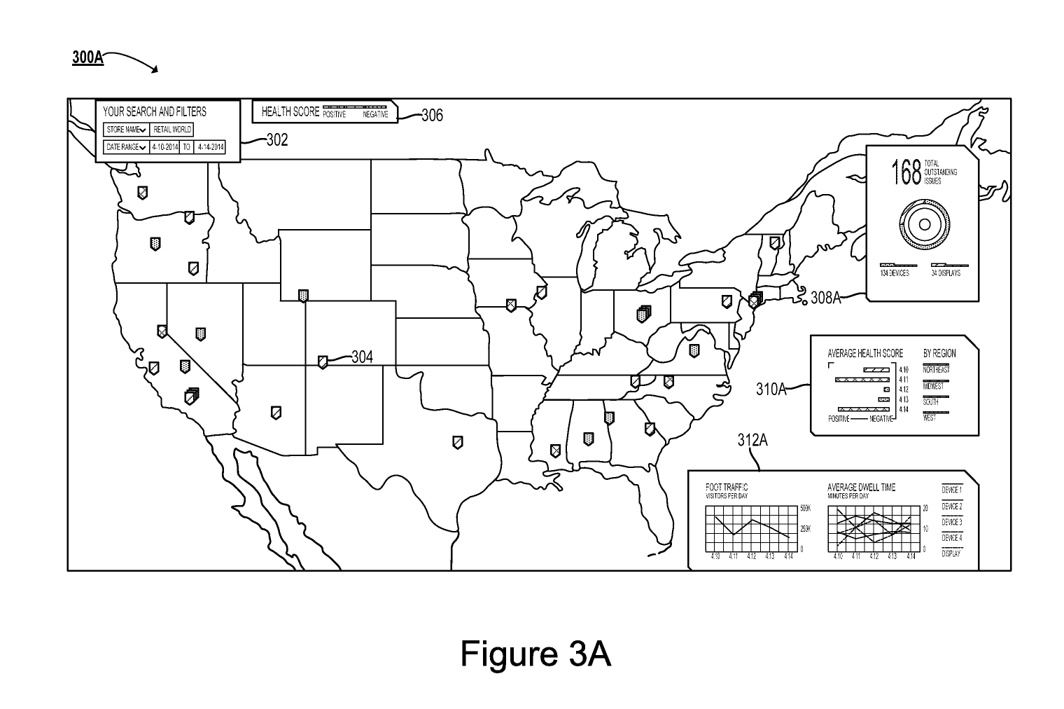

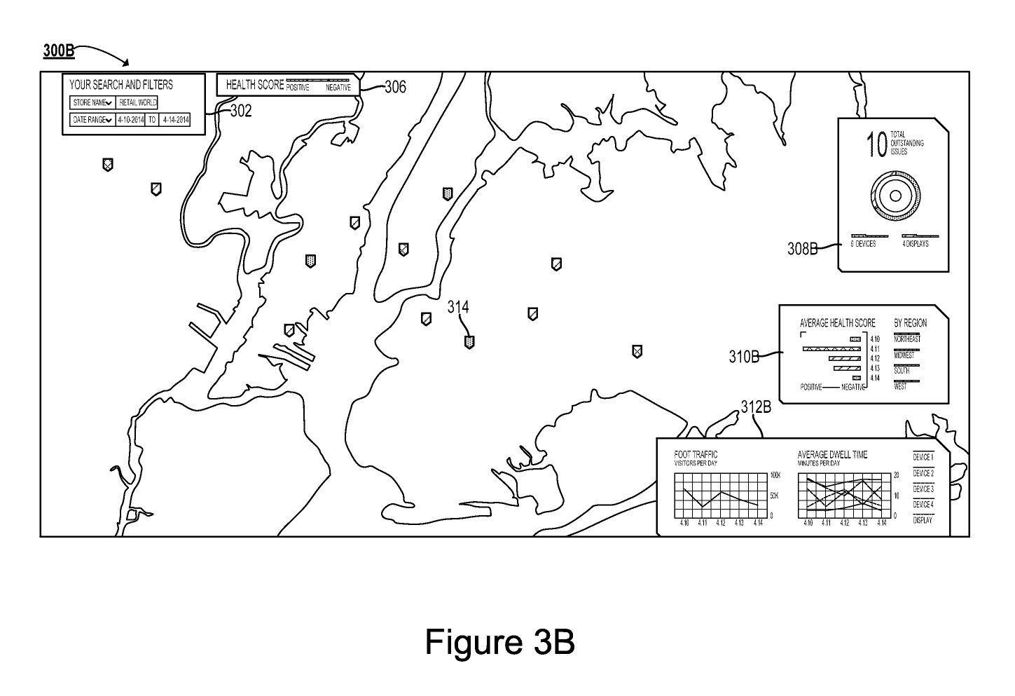

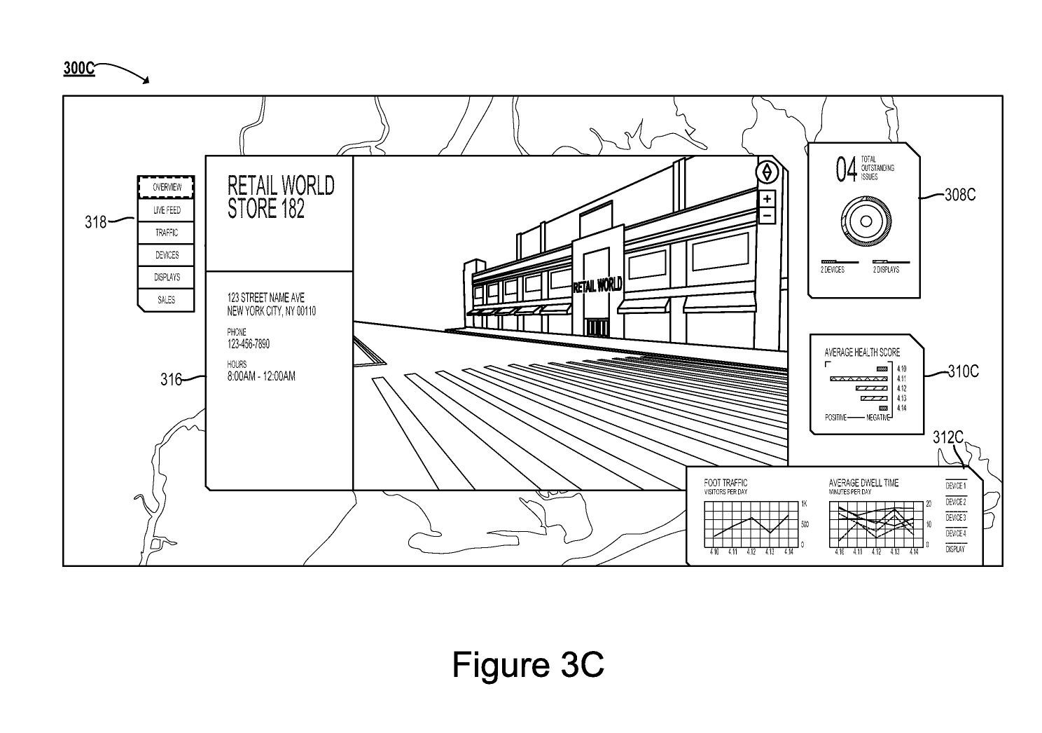

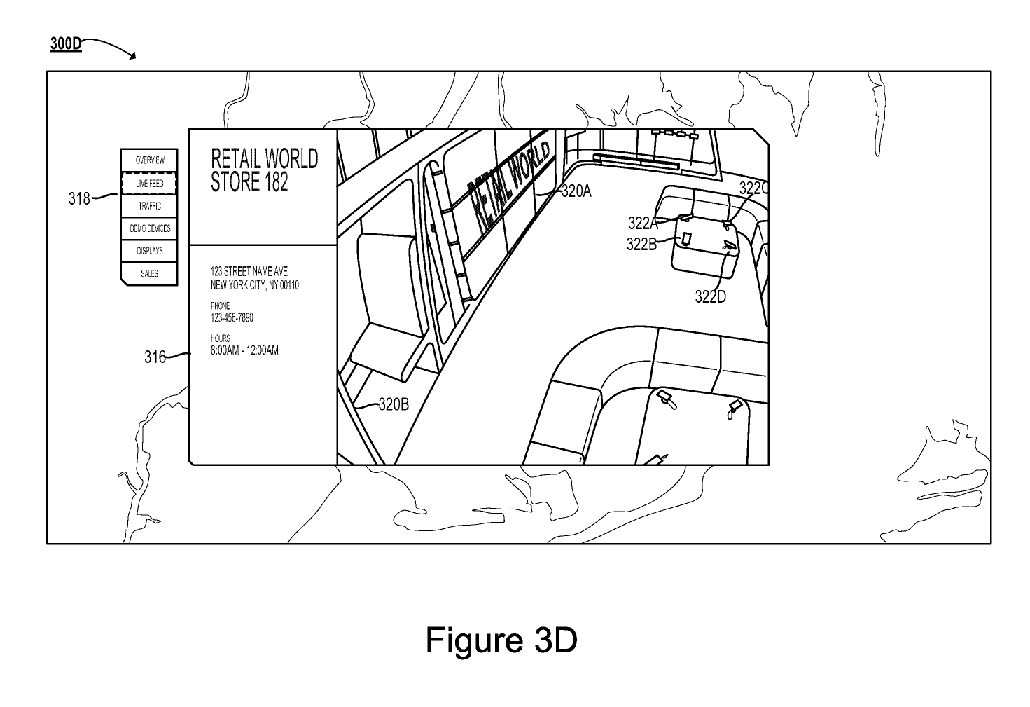

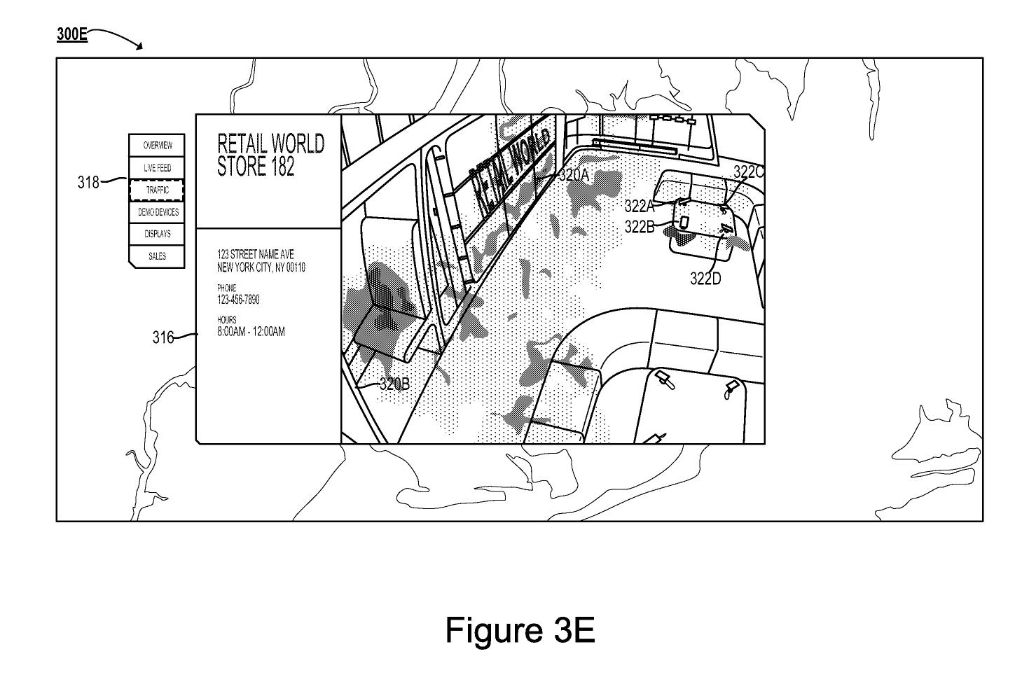

FIGS. 3A-3E depict several example screens within an example GUI that can be used for evaluating performance of one or more physical spaces. It should be noted that this example GUI is shown for illustration purposes only and is not meant to be limiting as other example GUIs are also possible without departing from the scope of the disclosure.

FIG. 3A shows an example screen state 300A showing an interface including a map of the United States. Screen state 300A is also shown to include a search field 302 that allows for selection of a store and/or a time period such as a date range. As shown, a user of the GUI has selected “Retail World” for the store name and a date range between “4-10-2014” and “4-14-2014”. Based on this selection, the system determines that the selected region includes all “Retail World” locations in the United States and determines the particular time period as being the selected date range. As such, the screen state also shows the various “Retail World” locations across the United States by way of marks/symbols, such as example mark 304.

While not shown in this example GUI, the GUI may also provide for selection of a specific performance metric to be determined. Regardless, the system may generate a map of the physical space, where the map includes a visual representation of at least one performance metric for the selected region and/or for the particular time. For instance, the example GUI shown in FIGS. 3A-3E depicts several performance metrics that are determined based on the search criteria discussed above and then displayed as part of the GUI. In particular, screen state 300A also shows an example legend 306 that can be used as reference to represent different ranges of values of a determined performance metric. Such values may be shown in form of colors, patterns, and/or numbers, among others. As shown, example legend 306 shows a “health score” that is used to assess overall performance of the physical spaces based on various criteria such as: safety, time, cost, resources, scope, quality, and/or actions, among others. In this example, some patterns denote a positive health score, other patterns denote a negative health score, and yet other patterns denote an average health score (e.g., between a positive and a negative).

Moreover, these patterns are reflected in various ways throughout the interface to denote the health scores of “Retail World” locations in the United States. As an example, each mark (i.e., presenting a “Retail World” location) is highlighted with one of the patterns representing a health score. For instance, example mark 304 is highlighted with a pattern denoting an average health score for this particular “Retail World” location. Additionally, these patterns are reflected in example performance charts 308A and 310A.

In one example, example performance chart 308A depicts performance of objects of interest within the physical spaces. In this example, the chart 308A depicts performance of all devices and displays positioned across “Retail World” locations in the United States. As shown, there are 134 device and 34 displays across “Retail World” locations in the United States, thereby amount to a total of 168 outstanding issues. Additionally, the chart 308A provides a visual representation of the percentage of devices having a corresponding positive health score, the percentage of devices having a corresponding negative health score, and/or the percentage of devices having a corresponding average health score. Further, such a visual representation is also provided in the context of displays as well as in the context of the total number of outstanding issues. Note that, while not shown, the example interface may also allow for selection of particular objects of interest within the physical spaces.

In another example, example performance chart 310A depicts performance during specific times within the particular selected time period and/or performance of different regions within the selected region. As shown, chart 310A depicts, for each date from the selected date range, an average health score across all “Retail World” location in the United States. Additionally, chart 310A depicts the average health score, during the selected date range, of “Retail World” locations in different regions of the United States such as the Northeast, Midwest, South, and West regions of the United States.

In yet another example, example performance chart 312A depicts performance metrics other than the health score discussed above. For instance, chart 312A portrays performance of objects of interest within the physical spaces, such as of specific types of devices (e.g., devices 1-4) and displays positioned throughout the various “Retail World” locations in the United States. As shown, the chart 312A depicts an average dwell time for each device/display, essentially representing a level of engagement of customers with each device/display. In this example, the chart 312A depicts an average number of minutes per day that each customer engages with a device/display. This level of engagement can be determined in various ways such as based on an amount of time a customer is positioned within a threshold distance of a device/display. In a further aspect, chart 312A also depicts foot traffic across all “Retail World” locations in the United States. This foot traffic essentially provides a measure for a number of visitors per day across all “Retail World” locations in the United States. Moreover, the chart 312A displays these performance metrics for each date from the selected date range. Other example performance charts are also possible.

FIG. 3B shows an example screen state 300B including a map of New York City. The GUI may transition from screen state 300A to screen state 300B based on user-input such as input corresponding to a zoom-in function on the GUI, among other possibilities. Upon transition to screen state 300B, the GUI may define the selected region as all “Retail World” locations in New York City. The GUI may also show the various “Retail World” locations in New York City by using marks/symbols such as example mark 314.

Given that the selected region has updated, the system may determine updated performance metrics and display the updated performance metrics in the GUI. As an example, chart 308A updates to chart 308B to show performance of devices/displays across “Retail World” locations in New York City. In another example, chart 310A updates to chart 310B to depict, for each date from the selected date range, an average health score across all “Retail World” locations in New York City. Additionally, chart 310B depicts the average health score, during the selected date range, of “Retail World” locations in different regions of the New York City such as the Northeast, Midwest, South, and West regions of New York City. Further, chart 312A updates to chart 312B to portray performance of objects of interest within the physical spaces, such as of specific types of devices and displays positioned throughout the various “Retail World” locations New York City. Moreover, chart 312B depicts foot traffic across all “Retail World” locations in New York City.

Next, FIG. 3C shows an example screen state 300C including a photo of particular physical space such as a photo of a particular “Retail World” store location in New York City. The GUI may transition from screen state 300B to screen state 300C based on user-input such as input corresponding to selection of a particular “Retail World” location on the map of New York City (e.g., selection of example mark 314), among other possibilities. Upon transition to screen state 300C, the GUI may define the selected region as the particular “Retail World” location that has been selected (e.g., store # 182).

Given that the selected region has updated, the system may determine updated performance metrics and display the updated performance metrics in the GUI. As an example, chart 308B updates to chart 308C to show performance of devices/displays at the particular “Retail World” location. In another example, chart 310B updates to chart 310C to depict, for each date from the selected date range, an average health score at the particular “Retail World” location. Additionally, chart 312B updates to chart 312C to portray performance of objects of interest within the physical spaces, such as of specific types of devices and displays positioned throughout the particular “Retail World” location. Moreover, chart 312C depicts foot traffic at the particular “Retail World” location.

Further, GUI portion 316 depicts the photo of the particular physical space. In addition to the photo, GUI portion 316 may also present information such as: a store number, store name, location, contact information, and/or hours of operation, among other possibilities. Moreover, the example GUI provides a menu 318 for navigation between various screens of the GUI. As an example, screen state 300C depicts an “overview” item from the menu 318.

Next, FIG. 3D shows an example screen state 300D including a visual representation of a particular physical space, such as a layout image or a live video feed of the particular “Retail World” location. The GUI may transition from screen state 300C to screen state 300D based on user-input such as input corresponding to selection of a “live feed” item from the menu 318, among other possibilities. The visual representation (e.g., the live feed) depicted in screen state 300D shows several objects positioned within the physical space. For instance, the physical space includes displays 320A and 320B (not visible) as well as devices 322A-322D, among others.

Given this arrangement, the GUI may provide a visual representation of performance metrics in association with the particular physical space. For instance, the GUI may provide a visual representation of performance in one or more selected region within the physical space or performance of the objects located in this physical space, among others. To illustrate, refer to FIG. 3E showing an example screen state 300E that includes a visualization, which may be referred to as a “Heat Map”, overlaying the visual representation of the physical space. The GUI may transition from screen state 300D to screen state 300E based on user-input such as input corresponding to selection of a “Traffic” item from the menu 318, among other possibilities. Note that the various transitions between screen states described herein should not be seen as limiting as the GUI may allow for transition from any given screen state to any other given screen state.

An example visualization may provide a 2D or 3D representation of a performance metric for various regions within a physical space, such as by use of varying colors or patterns each representing a different value of a performance metric. To develop the visualization, the system may determine the performance metric for each of a plurality of regions in the physical space, based on aggregation of physical characteristics (e.g., from determined physical characteristics) that are associated with a given region from the plurality of regions. Subsequently, the system can generate a map of the physical space, such that the map includes a visual representation of the performance metric for the plurality of regions. These regions may be predetermined regions, may be different regions selected by a user of the system and/or may be regions that are dynamically defined, among other possibilities.

The example visualization shown in FIG. 3E provides a representation of a performance metric corresponding to a level of engagement throughout the physical space. This level of engagement may be defined, for example, based on the number of people (e.g., in a given day) positioned in a given portion of the physical space for at least a threshold time period. In particular, this level of engagement may be determined, for example, based on sensor data received from proximity sensors positioned throughout the physical space. As shown, darker colors of the visualization may correspond to a higher level of engagement relative to lighter color. As an example, the example visualization depicts a relatively high level of engagement in the portion of the physical space that is in the vicinity of device 322B. Whereas, the example visualization depicts a relatively low level of engagement in the portion of the physical space that is in the vicinity of device 322C.

The example visualization in FIG. 3E is shown as a 3D map of the physical space that includes a 3D visual representation of the performance metric varying over a plurality of regions in the physical. This arrangement provides for a richer data set as performance of the physical space can be depicted along length, width, and depth of the physical space. Moreover, the GUI may allow for viewing different perspective of the physical space. For instance, if the visual representation of the physical space is a graphical layout of the physical space, the GUI may allow for user-input corresponding to movement and/or rotation of the layout. In this manner, the GUI may provide different perspectives of the example visualization. Further, in addition to a visualization, the GUI may also provide visual representation of performance metrics by way of annotating the map of the physical space, such as by providing characters representing performance metrics at different portions of the map. Other examples may also be possible.

### V. Additional Features

i. Visual Feedback

In an example implementation, the computing system may be in communication with a mobile device, such as device 114 for example. In this arrangement, the computing system may determine visual feedback based on a determined performance metric and then send a command, to the mobile device, to provide for the visual feedback on a display of the mobile device (e.g., display 116). For instance, the visual feedback may be indicative of suggested movement within the physical space where the mobile device (and perhaps the user of the mobile device) is positioned. In particular, this visual feedback may be in form of a list of direction providing suggested movement and/or visual directions overlaying a layout of the physical space, among other possibilities. In either case, the mobile device may display this visual feedback upon receiving the command.

In one example, sensor data may allow the system to determine areas of the physical space that are most crowded (e.g., areas having a high density of actors at a current time). Given such sensor data, the system may provide suggested movement based on movement that helps avoid such crowded area. In another example, sensor data may allow the system to determine areas of the physical space that have a high level of engagement. In this example, the system may provide suggested movement based on movement towards areas that have a high level of engagement. Other examples may also be possible.

In another example implementation, the computing system may be in communication with a projection system positioned within a physical space. In this arrangement, the computing system may send a command, to the projection system, to provide for visual feedback onto at least a portion of the physical space, where the visual feedback is indicative of the determined performance metric for the portion of the physical space. The projection system may project this visual feedback upon receiving the command.

In one example, the projection system may project a generated visualization (e.g., “Heat Map”) onto the physical space such as by projecting varying colors or patterns onto a floor or ceiling. This may specifically involve projecting the visualization onto the corresponding portions of the physical space indicative of the performance portrayed by the visualization. In another example, the projection system may project the suggested movements discussed above onto the physical space. For instance, the projection may include arrows indicating the suggested movement as the mobile device moves throughout the physical space. Other examples may also be possible.

ii. Predictive Analysis

In an example implementation, the computing system may have information stored in the database that is related to a plurality of historical performance metrics. These historical performance metrics may be previously determined performance metrics that have been stored in the database. Given this arrangement, the computing system may allow for predictive performance of a physical space such as at a future point in time. For instance, the computing system may receive input data (e.g., search criteria) including a request for a future performance metric that indicates performance of one or more selected region within the physical space over a future time period.

Upon receiving such input data, the computing system may obtain historical performance metrics from the data storage. These historical performance metrics may be specifically associated with (i) a historical time period related to the future time period and (ii) the selected different region. For instance, if the selected future time period is a Monday of an upcoming week, then the historical performance metrics may include any performance metrics associated with past Mondays and the selected regions. Moreover, the historical performance metrics correspond to the same metric (e.g., a level of happiness) as the requested future performance metric.

After obtaining the relevant historical performance metrics, the computing system may determine the future performance metric based on the obtained historical performance metrics. For instance, the value of the future performance metric may be an average of values of the historical performance metrics. As an example, the computing system may obtain three historical performance metrics corresponding to a level of happiness. These three historical performance metrics may have value of 3, 4, and 5 (e.g., on a scale of 10). As such, the computing system may determine the future performance metric, corresponding to a predicted future level of happiness, to have a value of 4. Note, however, that other example computations may also be possible to determine future performance metrics.

In a further aspect, the computing system can determine trends based on information that is obtained over time. For instance, the computing system can determine that a particular event (e.g., a determined performance metric) consistently takes place at a particular time and/or in a particular location within a physical space. For example, the computing system may determine that a level of happiness in a physical space is always below a threshold value between noon and 1 PM every day of the week. Upon such a determination, the computing system may provide this information to a user of the system by way of text or by way of a visual representation, among other possibilities.

In yet a further aspect, the computing system can determine correlations based on information that is obtained over time. For instance, the computing system can determine that a particular event (e.g., a determined performance metric) consistently takes place when a different event also takes place at the same time. For example, the computing system may determine that areas of a physical space that are lit correspond to a relatively high level of happiness while areas of the physical space where no lighting is provided correspond to a relatively low level of happiness. Upon such a determination, the computing system may provide this information to a user of the system by way of text or by way of a visual representation, among other possibilities.

iii. Other Example Physical Spaces

As noted above, example implementations are not limited to retail spaces and may extend to a variety of other physical spaces such as manufacturing facilities, distribution facilities, office spaces, shopping centers, festival grounds, and/or airports, among other examples. Moreover, as noted above, actors in such physical spaces may include people, animals, machines, robotic systems, and/or objects, among other possibilities.

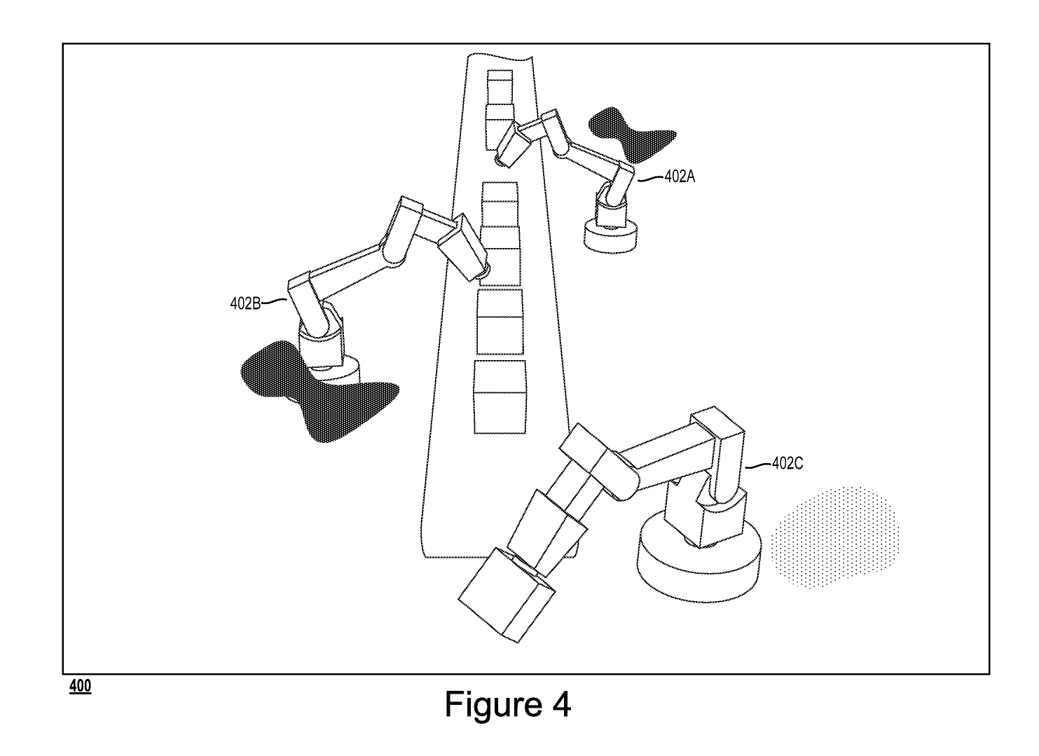

To illustrate, refer to FIG. 4 showing an example screen state 400. Screen state 400 shows a visual representation of a particular physical space, such as a layout image or a live video feed of an assembly line in a manufacturing facility. As shown, three robotic arms 402A-402C operate to perform different tasks at different regions of the assembly line. While not shown, people (or other actors) may also operate to perform tasks at different regions of the assembly line, such as by operating the robotic arms 402A-402C for example. Given the above arrangements, the example implementation disclosed herein may be used to evaluate performance of the assembly line, and in particular to evaluate performance at the different regions of the assembly line.

In one example, the system may use the above implementations to provide for a level of happiness at the various regions of the assembly line. For instance, the system may provide a metric representing the level of happiness in the vicinity of each of the robotic arms 402A-402C. This level of happiness may, for example, represent satisfaction of people (e.g., workers) operating the robotic arms 402A-402C at different regions of the assembly line. Thus, an operator of the system (e.g., a manager) can use this performance data to determine regions corresponding to a low level of happiness, and thereby take steps to improve a work setting.

In another example, the system may use the above implementations to provide for a level of interaction at the various regions of the assembly line. For instance, the system may provide a metric representing the level of interaction in the vicinity of each of the robotic arms 402A-402C. This level of interaction may, for example, be based on a duration that people (e.g., workers) spend in the vicinity of a robotic arm. Thus, an operator of the system (e.g., a manager) can use this performance data as an indicator of which of the robotic arms 402A-402C mostly operate independently and which of the robotic arms 402A-402C generally operate with assistance of at least one person.

By way of example, FIG. 4 depicts a visualization (e.g., a “Heat map”) such as the visualization discussed above in association with FIG. 3E. The example visualization shown in FIG. 4 provides a representation of a performance metric corresponding to a level of interaction throughout the physical space. This level of interaction may be defined, for example, based on the number of people (e.g., in a given day) positioned in a given portion of the physical space for at least a threshold time period. In particular, this level of interaction may be determined, for example, based on sensor data received from proximity sensors positioned throughout the physical space (e.g., incorporated within the robotic arms 402A-402C). As shown, darker colors of the visualization may correspond to a higher level of interaction relative to lighter color.

For instance, the example visualization depicts a relatively high level of interaction in the portion of the physical space that is in the vicinity of robotic arm 402A as well as in the vicinity of robotic arm 402B. Whereas, the example visualization depicts a relatively low level of interaction in the portion of the physical space that is in the vicinity of robotic arm 402C. Given such visualization, an operator of the system can use this performance data as an indicator that robotic arm 402C mostly operates independently while robotic arms 402A-402B generally operate with the assistance of a person. Other examples may also be possible.

### VI. Conclusion

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example implementations described herein and in the figures are not meant to be limiting. Other implementations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other implementations can include more or less of each element shown in a given figure. Further, some of the illustrated elements can be combined or omitted. Yet further, an example implementation can include elements that are not illustrated in the figures.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

1. A computing system comprising:
one or more processors;
a non-transitory computer readable medium; and
program instructions stored on the non-transitory computer readable medium and executable by the one or more processors to:
based on sensor data received from one or more sensors positioned in a physical space, determine one or more physical characteristics of one or more actors located in the physical space, and, respectively for each of the one or more physical characteristics, (i) an associated time and (ii) an associated location within the physical space of at least one actor from the one or more actors;
store information representative of the one or more determined physical characteristics, associated times, and associated locations;
after the information is stored, receive, via a graphical interface that is displayed on a display device and that includes a visual representation of the physical space, input data that (i) designates, on the visual representation of the physical space, a shape defining a custom region within the physical space and (ii) comprises a request for a performance metric indicating performance of the custom region within the physical space over a particular time period;
determine the performance metric based on an aggregation of physical characteristics, from the one or more determined physical characteristics, that have, in accordance with the stored information, (i) associated times within the particular time period and (ii) associated locations within the custom region; and
cause the display device to display on the graphical interface a visual representation of the determined performance metric.

2. The computing system of claim 1, wherein each of the one or more physical characteristics corresponds to a value defining the physical characteristic, and wherein determining the performance metric comprises determining a weighted average of values defining the physical characteristics that have, in accordance with the stored information, (i) associated times within the particular time period and (ii) associated locations within the custom region.

3. The computing system of claim 1, wherein the display device is a touch screen display, and wherein the input data is based on one or more touch gestures that are provided on the touch screen display and that designate the shape defining the custom region within the physical space.

4. The computing system of claim 1, wherein the input data designating a shape comprises the input data specifying a custom shape to define the custom region within the physical space.

5. The computing system of claim 1, wherein the visual representation of the physical space comprises a three-dimensional visual representation of the physical space, and wherein the visual representation of the determined performance metric comprises a three-dimensional visual representation of the determined performance metric.

6. The computing system of claim 1, wherein the custom region comprises a three-dimensional section of the physical space, and wherein determining the performance metric is based on an aggregation of physical characteristics, from the one or more determined physical characteristics, that have, in accordance with the stored information, (i) associated times within the particular time period and (ii) associated locations within the three-dimensional section of the physical space.

7. The computing system of claim 1, wherein the computing system is in communication with a projection system, the computing system further comprising program instructions stored on the non-transitory computer readable medium and executable by the one or more processors to:
send a command, to the projection system, to provide for visual feedback onto at least a portion of the physical space, wherein the visual feedback is indicative of the determined performance metric for the portion of the physical space.

8. The computing system of claim 1, wherein the computing system is in communication with a mobile device, the computing system further comprising program instructions stored on the non-transitory computer readable medium and executable by the one or more processors to:
determine visual feedback based on the performance metric; and
send a command, to the mobile device, to provide for the visual feedback on a display of the mobile device.

9. The computing system of claim 8, wherein the visual feedback is indicative of suggested movement within the physical space.

10. The computing system of claim 1, wherein the computing system further comprise data storage containing information related to a plurality of historical performance metrics, the computing system further comprising program instructions stored on the non-transitory computer readable medium and executable by the one or more processors to:
receive different input data comprising a different request for a future performance metric indicating performance of a selected different region within the physical space over a future time period;
in response to receiving the different input data, obtain from the data storage historical performance metrics, from the plurality of historical performance metrics, that are associated with (i) a historical time period related to the future time period and (ii) the selected different region; and
determine the future performance metric based on the obtained historical performance metrics.

11. A method comprising:
based on sensor data received from one or more sensors positioned in a physical space, determining, by a computing system, one or more physical characteristics of one or more actors located in the physical space, and, respectively for each of the one or more physical characteristics, (i) an associated time and (ii) an associated location within the physical space of at least one actor from the one or more actors;
storing information representative of the one or more determined physical characteristics, associated times, and associated locations;
after the information is stored, receiving, via a graphical interface that is displayed on a display device and that includes a visual representation of the physical space, input data that (i) designates, on the visual representation of the physical space, a shape defining a custom region within the physical space and (ii) comprises a request for a performance metric indicating performance of the custom region within the physical space over a particular time period;
determining the performance metric based on an aggregation of physical characteristics, from the one or more determined physical characteristics, that have, in accordance with the stored information, (i) associated times within the particular time period and (ii) associated locations within the custom region; and
causing the display device to display on the graphical interface a visual representation of the determined performance metric.

12. The method of claim 11, wherein the one or more physical characteristics comprise one or more of: (i) body language and (ii) facial expression.

13. The method of claim 11, wherein the one or more physical characteristics comprise face temperature.

14. The method of claim 11, wherein the performance metric corresponds to a rate of performance of a particular action within the custom region.

15. The method of claim 11, wherein each of the one or more physical characteristics corresponds to a value defining the physical characteristic, and wherein determining the performance metric comprises determining a weighted average of values defining the physical characteristics that have, in accordance with the stored information, (i) associated times within the particular time period and (ii) associated locations within the custom region.

16. The method of claim 11,
wherein causing the display device to display on the graphical interface a visual representation of the determined performance metric comprises causing the display device to display a map of the physical space that shows the visual representation of the performance metric for the custom region.

17. A non-transitory computer readable medium having stored therein instructions executable by one or more processors to cause a computing system to perform functions comprising:
based on sensor data received from one or more sensors positioned in a plurality of physical spaces, determining, one or more physical characteristics of one or more actors located in the plurality of physical spaces, and, respectively for each of the one or more physical characteristics, (i) an associated time and (ii) an associated location within the plurality of physical spaces of at least one actor from the one or more actors;
storing information representative of the one or more determined physical characteristics, associated times, and associated locations;
after the information is stored, receiving, via a graphical interface that is displayed on a display device and that includes a visual representation of one or more of the plurality of physical spaces, input data that (i) designates, on the visual representation of one or more of the plurality of physical spaces, one or more shapes defining one or more custom regions within the plurality of physical spaces and (ii) comprises a request for a performance metric indicating performance respectively of the one or more custom regions within the plurality of physical spaces over a particular time period;
determining, respectively for each of the one or more custom regions, the performance metric based on an aggregation of physical characteristics, from the one or more determined physical characteristics, that have, in accordance with the stored information, (i) associated times within the particular time period and (ii) associated locations within a given region from one or more custom regions; and
causing the display device to display on the graphical interface a visual representation of the one or more determined performance metrics.

18. The non-transitory computer readable medium of claim 17, wherein the input data further comprises selection of a particular physical space from the plurality of physical spaces, and wherein the one or more custom regions are each within the particular physical space.

19. The non-transitory computer readable medium of claim 17, wherein the input data further comprises selection of particular physical characteristics, from the one or more physical characteristics, to be used to determine the performance metric.

20. The non-transitory computer readable medium of claim 17, wherein each of the one or more physical characteristics corresponds to a value defining the physical characteristic, and wherein determining, respectively for each of the one or more custom regions, the performance metric comprises determining a weighted average of values defining the physical characteristics that have, in accordance with the stored information, (i) associated times within the particular time period and (ii) associated locations within a given region from one or more custom regions.
